(19) United States
(12) Patent Application Publication
(10) Pub. No.: US 2006/0112044 A1
(43) Pub. Date: May 25, 2006

(54) Method of producing solutions to a concrete multicriteria optimisation problem

(76) Inventors: Fabien Le Huede, Massy (FR); Michel Grabisch, Saint-Remy-Les-Chevreuse (FR); Christophe Labreuche, Orsay (FR); Pierre Saveant, Paris (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/543,508

(22) PCT Filed: Jan. 27, 2004
(86) PCT No.: PCT/FR04/00178

§ 371 Date: Jul. 27, 2005

(30) Foreign Application Priority Data
Jan. 28, 2003 (FR) 03/00898

(51) Int. Cl. G06N 5/02

(52) U.S. Cl. 706/46

(57) ABSTRACT

The method in accordance with the invention is a method according to which several decision criteria and a preference relation based on these criteria between the solutions of the problem are established. Modeling of the problem to be solved is established by obtaining solutions constructively via a tree search process. A tree search strategy has been established for each criterion. The strategies are alternated so as to find solutions of increasing quality; the strategies are chosen dynamically as a function of the last solution found. The alternation of strategies continues until a stopping condition is satisfied. The last solution found before the satisfaction of the stopping condition is exhibited as the solution to the problem set.

The present invention pertains to a method making it possible to produce solutions to a concrete problem of multicriterion optimization.

Numerous industrial problems relate both to multicriterion decision making and to optimization. On the one hand, tree search techniques make it possible to solve a large number of problems of combinatorial or continuous optimization in the mono-objective case. Multicriterion decision aids, on the other hand, offer tools and procedures for modeling the preferences of a decision maker and for comparing the solutions of a multicriterion problem. However, numerous optimization systems would require multicriterion modeling of the preference relation between the solutions, which would allow better modeling of the problem encountered and would make it possible to respond thereto with solutions of better quality. Likewise, within the context of problems tackled by multicriterion decision aid, the set of solutions is sometimes too vast and it is impossible to compare all the elements thereof.

The invention is more especially concerned with the use of tree procedures for solving multicriterion optimization problems. In the mono-objective case, the objective function determines in large part the way in which the search tree is constructed and the strategy adopted for its exploration. The choice of these elements which constitute a strategy for searching for solutions has a large influence on the effectiveness of the solution process. In the multicriterion case, on the other hand, it is often very difficult to determine a search strategy enabling a problem to be solved effectively in most cases.

The present invention is aimed at a method making it possible to produce semiautomatically or, preferably, automatically, solutions to a multicriterion optimization problem, which are applicable in an effective manner in most cases, that is to say capable of accelerating the convergence of the search process to an optimal solution.

The method in accordance with the invention is a method according to which:
several decision criteria and a preference relation based on these criteria between the solutions of the problem are established;
a modeling of the problem to be solved is established
   and it is characterized by the fact that
solutions are obtained constructively via a tree search process;
a tree search strategy has been established for each criterion;
the strategies are alternated so as to find solutions of increasing quality;
the strategies are chosen dynamically as a function of the last solution found;
the alternation of strategies continues until a stopping condition is satisfied;
the last solution found before the satisfaction of the stopping condition is exhibited as the solution to the problem set.

According to another characteristic of the invention, the preference relation between the solutions of the problem is modeled by an aggregation function H, which is, preferably, a Choquet integral.

According to yet another characteristic of the invention, following each search, the value of an indicator is determined for each criterion as a function of the last solution found and this indicator makes it possible to determine the strategy which will be used during the next search.

According to yet another characteristic of the invention, the indicator used for the dynamic choice of a strategy is the indicator of maximum utility.

According to yet another characteristic of the invention, the indicator used for the dynamic choice of a strategy is the indicator of mean utility.

According to yet another characteristic of the invention, local constraints are set on the various searches. Advantageously, the local constraint set for a search on a criterion is a constraint of improving this criterion and this constraint is set at each search. Alternatively, the local constraint set for a search on a criterion is a constraint of improving this criterion and this constraint is set only when a criterion is selected several times in succession to guide the search, starting from the second consecutive search on this criterion.

According to yet another characteristic of the invention, the strategies associated with the various criteria, the local constraints on the searches and the stopping condition in the search process are used to find an optimal solution to the problem and to prove the optimality of this solution.

According to yet another characteristic of the invention, the modeling of the problem and the search for solutions are carried out in a constraints solver.

The present invention will be better understood on reading the detailed description of a mode of implementation, taken by way of nonlimiting example.

The method of the invention is therefore a method for solving multicriterion optimization problems which is based on the alternating of searches according to various mono-objective strategies (one per criterion). In order for the method to be effective, the choice of a strategy at a moment of the search must be performed adaptively as a function of the data of the problem and of the state of the search.

Firstly, the concepts which are important for the understanding of the method of the invention are defined, as are the notation and terminology used in the subsequent description.

An optimization problem is defined by a set of decision variables each taking their value from among a set called the domain, by a set of logic relations, these variables restricting the combinations of values that are allowed, called constraints. Finally, this problem is defined by an objective function which characterizes the quality of a solution (one often speaks of a cost function in the case of a minimization problem and of a profit function or utility function if dealing with a maximization problem). A solution to such a problem is an assignment of a value from its domain to each decision variable which satisfies all the constraints. The set of optimal solutions, in the case of a minimization problem, corresponds to the solutions having the smallest value of the cost function among the set of existing solutions. The treatment of an optimization problem consists in searching for the low cost solutions, if possible optimal, or as the case may be in proving the absence of a solution.

When the domains of the variables are finite sets of values, the problem is a combinatorial optimization problem. When the domains are intervals of the set of reals, the problem is a continuous optimization problem. For a given optimization problem, the solution search space corresponds to the space formed by the Cartesian product of the domains of the variables. The solution space corresponds to the set of solutions of the problem.

Optimization problems are commonly encountered in most branches of industry and services. An exemplary problem consists in delivering a certain number of orders to geographically dispersed customers at least cost. The decision variables of the problem are the dates and times of delivery of these goods. The constraints describe the transport network, the timetables of availability of the customers to receive the goods, the capacity of the delivery vehicles, the timetables of the employees who make the deliveries. The cost function to be minimized is calculated as a function of the distance traveled in satisfying the orders.

Transport problems are encountered in extremely varied domains, among which are telecommunications, aeronautics, defense. The other large classes of optimization problems are, among others, the problems of scheduling (scheduling of a production line, sequencing of the tasks dealt with by a processor), problems of configuration, problems of the use of time and planning, problems of partitioning.

Multicriterion decision aid techniques are aimed at modeling the preferences of an expert in the most faithful manner possible. Such modeling then allows the construction of suitable tools capable of assisting or of replacing a decision maker with regard to complex problems. Solving a multicriterion decision problem consists in modeling the way in which an expert or a decision maker ranks a set of potential solutions (each called an “alternative”) described by a set of attributes or viewpoints. In order to perform the ranking (or even simply the choice of an alternative), the “performance” (level of satisfaction) of the various possible alternatives is evaluated according to each of the viewpoints deemed to be relevant for the problem. The modeling of the preferences of an expert is carried out with the aid of a function aggregating the performance of the various alternatives. Two approaches are used: the “Compare then Aggregate” (CA) approach consists firstly of a pairwise comparison, criterion by criterion, of the performance of the alternatives, then of an aggregation of these comparisons so as to establish the preference relation; the “Aggregate then Compare” (AC) approach summarizes the value of an alternative through an overall score calculated on the basis of the performance of an alternative with regard to the various criteria. The best alternative in the sense of the preferences of the expert is called the preferred solution.

For example, we consider various solutions to the abovementioned problem of delivering goods. The cost of the solution making it possible to deliver the goods may not be the sole criterion of choice. We may also wish to minimize the duration of delivery (the cheapest solution is not necessarily the fastest), give priority to more important orders, minimize the number of deliveries that are late or the global delay when it is impossible to keep to the given timescales. A decision maker may then prefer a solution which offers a compromise between the various criteria to the minimum cost solution.

Multicriteria decision aid techniques make it possible to rank a certain number of known alternatives (for example, for the choice of a site for the installation of a nuclear power station). Generally, they make it possible to evaluate situations or the suitability of individuals (evaluation of the relevance of the response to a tender for offers, evaluation of students, etc.).

The problems that the invention has to model and solve are multicriterion optimization problems characterized by the fact that the solution space is modeled, as in a classical optimization problem, by a set of decision variables and of constraints, and that the preference relation between the solutions is modeled by a multicriterion function. Solving a multicriterion optimization problem therefore amounts to finding a preferred solution to the problem, or at least a solution of good quality. Within the context of multicriterion optimization problems, an optimal solution is therefore a preferred solution. It is in general impossible to compare all the solutions of an optimization problem, and it may be noted that the introduction of multiple criteria often renders the search for an optimal solution even more complex. The invention therefore proposes a method making it possible to take account of the specifics of multicriterion optimization problems and to allow their solution in reasonable times. This method is based on the use of tree procedures for searching for solutions to the problem.

The search for a solution to an optimization problem may be done in various ways. One of the most widespread solution procedures is the separate-evaluate (branch and bound) process which makes it possible to perform an implicit traversal of the solution space with the aid of a search tree.

The principle of the construction of a search tree is as follows: at each node of the tree, a parent subproblem is divided into simpler daughter subproblems until the subproblems to be solved are trivial. The division into subproblems (called separation) is carried out in such a way that a solution to a daughter subproblem is a solution to the parent subproblem and that the union of the daughter subproblems is equivalent to the parent subproblem. The main problem is the node at the root of the tree. Any solution of a subproblem is therefore a solution of the main problem. When a subproblem has no solution, the node corresponding to this subproblem is pruned from the search tree. If all the daughters of a parent subproblem have been pruned, then there exists no solution to the parent subproblem and it may in turn be pruned. The separation rule gives the way in which the nodes are separated (that is to say the way in which a parent subproblem is divided into daughter subproblems). For example, we consider a delivery problem with a single vehicle, and p decision variables t₁, . . . , tₚ which represent the delivery dates of the next p orders. If we decide to make the deliveries as quickly as possible, then only the sequencing of the deliveries is important: it makes it possible to determine in an exact manner the earliest date at which each delivery is made. A solution may therefore be obtained by determining for every pair i,j, i<j, whether tᵢ<tⱼ or tᵢ>tⱼ. At a node of the tree corresponding to the subproblem P we therefore select a pair i,j of variables for which this disjunction has not yet been solved and we separate P into P₁={P∩(ti<tj)} and P₂={p∩(ti≧tj)}.

There exist various ways of searching for solutions in a search tree as a function of the order in which the nodes are constructed. Given a search tree under construction, it is necessary to choose the next node to be separated and one of the separation decisions which may be applied thereto. The component which determines the next node to be separated is called the exploration strategy. The exploration strategy most commonly employed is the “depth first” strategy: each time a node is created, it is separated. In this strategy the second daughter of a node is explored only when all the descendants of the first daughter have been explored. This strategy is beneficial since it makes it possible to find solutions very rapidly and can be implemented easily with the aid of a stack. A second strategy is the “width first” strategy where all the nodes of a level of the tree are separated before separating the next ones. In practice this strategy is never used since it consumes too much memory. Finally, a third strategy is the “best first” strategy where an evaluation function allocates a score to the nodes that have not yet been separated; the node having obtained the best score is then selected for separation. The choice of which separation decision is applied to a node determines the order in which these separations are sequenced (in the example above, the order in which the pairs i,j are chosen, and whether node P₁={P∩(ti<tj)} is created before node P₂={P∩(ti≧tj)} or vice versa). This order, generally chosen empirically, is often given by a heuristic criterion. Its aim is in general to precipitate the discovery of a new solution or, conversely, to more quickly detect contradictions that prove that a node does not admit of a solution.

In optimization, the “branch and bound” principle is used: when a solution is found, only the nodes that may lead to a better solution are separated. At each node, the evaluation function makes it possible to determine a bound (lower in minimization) of the objective function for the corresponding subproblem: this is the best value that it will be possible to obtain for this subproblem. If this bound is of worse quality than the best solution already found, the node is pruned. This process makes it possible to find only solutions of increasing quality and to avoid needlessly traversing large parts of the search tree. It has been proven that the optimal solution has been obtained when we no longer find any solution that improves the objective.

In conclusion, the search for a solution to an optimization problem in a search tree depends on the separation rule, on the evaluation function, on the exploration strategy and on a heuristic criterion. The separation rule, the exploration strategy and the heuristic criterion determine the order in which the nodes will be constructed and therefore the order in which the solutions will be found. The combination of these various elements is called the search strategy. According to the objective function or the criterion to be optimized it is important to adopt a search strategy making it possible to rapidly find solutions of good quality so as thereafter to be able to prune large parts of the search tree that cannot lead to better solutions. In this sense, in the subsequent description, a criterion will be said to “guide” a search when it is this criterion that determines the search strategy adopted.

A search strategy makes it possible to steer the search as rapidly as possible towards solutions of good quality (and if possible towards an optimal solution). Finding a good solution rapidly then makes it possible, according to the “branch and bound” principle, to prune large parts of the search tree that cannot lead to better solutions. In the multicriterion case, a strategy making it possible to rapidly obtain solutions of good quality with regard to one criterion may be very ineffective for another one. Thus, the phenomena of compensation and more generally of interaction between criteria often make it very difficult to define a global strategy allowing a problem to be solved effectively in all cases of interest.

Numerous procedures have been developed for solving multicriterion optimization problems. Nevertheless few of them propose combining the effectiveness of tree procedures with the capacity to model preferences of multicriterion decision aid techniques. Among these approaches the invention has adopted the formalism of CP-nets, the formalism of flexible constraints, an approach for solving multicriterion scheduling problems and the PBS formalism.

Among the various approaches, CP-nets (C. Boutilier et al., “A Constraint-Based Approach to Preference Elicitation and Decision Making”, Working Papers of the AAAI Spring Symposium on Qualitative Preferences in Deliberation and Practical Reasoning, Jon Doyle and Richmond H. Thomason editors, pp. 19-28, Menlo Park, Calif., 1997) propose a formalism where the preferences are modeled by a set of rules which seem, however, to give rise to problems of complexity both during the modeling of the preference relation between the solutions and during the search for solutions (a very large number of rules seem to be necessary and difficult to obtain by an expert). The problems of modeling preferences are also tackled via the use of flexible constraints (S. Bistarelli et al., Semiring-Based CSPs and Valued CSPs: Frameworks, Properties, and Comparison, CONSTRAINTS No. 4, 199-240, 1999). This approach is deemed to be especially beneficial when dealing with overconstrained problems and when seeking solutions violating these constraints as little as possible. However, the multicriterion approach is more suited for the modeling of preferences in the presence of multiple criteria. In both cases (CP-nets and flexible constraints), the problem of the search for solutions remains complex and no specific approach has been proposed.

A more pragmatic approach is adopted in (F. Focacci and D. Godard, “A Practical approach to multi-criteria optimization problems in constraint programming”, Proceedings of the Fourth International Workshop on Integration of AI and OR Techniques in Constraint Programming for Combinatorial Optimisation Problems (CP-AI-OR'02), pp. 65-75, N. Jussien and F. Laburthe editors, Le Croisic, France, 2002) for solving a scheduling problem with three objectives aggregated by a weighted sum. The objective of the approach is to produce a good quality solution in a limited time.

Thus, each time a solution is found, the procedure imposes either a simultaneous improvement of all the objectives, or an improvement of one objective and, to some extent, the nondegradation of the other objectives (it is possible, for example, to tolerate a degradation of 10%). According to the authors, the best results are obtained by successively using the various modes of posing improvement constraints for various objectives. The approach is beneficial since, even though the same search strategy is used for all the searches, it already highlights the benefit of alternating the optimizations with regard to the criteria of the problem so as to improve a global objective. Nevertheless, the procedure of alternating the various searches appears to have been designed empirically and to be more especially dedicated to the scheduling problem. One also notes the benefit of the constraints on the criteria which make it possible to accelerate the search but which may also delete interesting solutions.

Work on programming based on preferences in combinatorial optimization problems has stemmed from the nonmonotonic reasoning. This allows the modeling of preferences (usually in the form of rules) between decisions which will have to be taken in the course of the search for solutions (for example, dealing with one task before another in scheduling). These preferences are then used to determine the order in which the decisions are taken during the search, which is carried out by a constraints solver. Such work has culminated in the design of a procedure called “Preference Based Search” (PBS). PBS was developed and implemented for the solving of scheduling problems and of configuration problems. It uses the preferences on the decisions both to guide the search and to reduce the search space by deleting nonpreferred solutions. The most recent developments on PBS generalize the procedure to take account of the preferences on criteria (U. Junker, “Preference-based search and multi-criteria optimization”, Proceedings of the Fourth International Workshop on Integration of AI and OR Techniques in Constraint Programming for Combinatorial Optimization Problems (CP-AI-OR'02), pp. 34-47, N. Jussien and F. Laburthe editors, Le Croisic, France, 2002). The formalism is extended so as to be able to express the fact that a criterion c₁ is preferred to another c₂ (c₁ πc₂) or that a set of criteria must be balanced (c₁≈c₂). The balance between two criteria is established by virtue of a “lexi-max” type operator (see H. Moulin, Axioms of Cooperative Decision-Making. Cambridge Univ. Press, 1988). To search for solutions, a PBS master program selects criteria on the basis of the preferences of the decision maker and returns them as objectives to a constraints solver. This algorithm actually performs several successive lexicographic optimizations for the various orders of criteria permitted by the preferences. Thus, by using the principle of the “ε-constraints” method (K. M. Miettinen, Nonlinear multiobjective optimization, edition Kluwer academic publisher, 1999), PBS makes it possible to exhibit the whole set of preferred solutions of the problem. PBS uses the alternation of optimizations on the criteria to traverse the search space and exhibit the whole set of preferred solutions (and not to improve a solution). Specifically, the formalism used for the modeling of the preferences has the advantage of being relatively simple but it does not allow a fine representation of the preferences (in particular of the compensation phenomena). The method must therefore return a large number of solutions to the decision maker who will then have to make a choice among them. This may be desirable in certain cases (for searching for a trip on the Internet for example), but especially inconvenient within an automatic decision context (automatic management of aerial conflicts, evaluation of the threat and protection of a vessel).

The invention therefore proposes an approach dedicated to the search for solutions within the context of the solving of multicriterion optimization problems.

The approach proposed for the guidance of a multicriterion search is to define a guidance strategy adapted by criterion and to employ these various strategies for the search for multicriteria solutions of increasing quality. The idea is to alternate monocriteria searches using these strategies while imposing an improvement of the global satisfaction level with each new solution until a given stopping condition is satisfied (for example, until the optimality of the last solution found has been proven).

At the end of a search on a criterion, we determine the criterion which “will guide” the next search as a function: of the last solution found; of the possible improvements in each criterion; and of the preference relation between the solutions. It is as it were the criterion with regard to which improvement is of most benefit.

At each search, to attempt to further increase the speed of convergence to a good solution, it is moreover possible to impose improvements on the criteria by a set of additional constraints, which is valid only for the time of a search. This type of constraint will be called constraints “local” to a search. These “ephemeral” constraints will be added to the constraint of improving the global quality of the solutions sought. It also makes it possible to express the fact that it is not permitted to degrade a criterion by more than 10% in the course of a search, as presented in the Focacci-Godard 2002 article. As in this article, these constraints must be employed with precaution, since they may delay, or even prevent, the discovery of good solutions (and more particularly of optimal solutions).

The process terminates when a stopping condition defined by the user has been satisfied (for example, when a search does not manage to find any improving solution).

The alternating of the various strategies thus makes it possible to traverse various interesting regions of the search space while the constraints added to each solution found make it possible to converge to an optimal solution.

The process described in the above steps, dedicated to searching for solutions to a multicriterion problem has been dubbed MCS (Multi-Criteria Search).

From an algorithmic point of view, the principles set out above may be translated as follows:

MCS

u := (u₁,...,uₙ), s* := nil, s := nil, c :=0, local := false
while not(<checkTermination>(local,s*,s,u,c))

c := <getNextCriterion>(s*,u),
local := <setLocalConstraints>(s*,u,c),
s := maximize(u[c], getStrategy(c)),
if (s ≠ nil)

s* := s

endif

endwhile
return s*

end

The criteria to be maximized are represented by the vector of variables u=(u₁, . . . , uₙ), the best solution found by the algorithm is stored in the variable s* and the variable s is used for storing intermediate solutions. The variable “c” contains the index of the criterion on which a search will be launched and the variable “local” indicates whether a local constraint has been set during the last search for solutions. The chevrons (<checkTermination>, <getNextCriterion>, <setLocalConstraints> indicate the characteristic functions of the MCS algorithm which will have to be defined by the user as a function of his problem. The algorithm operates in the following manner: a “while” loop is repeated as long as the stopping condition contained in the function <checkTermination> has not been satisfied. At each iteration, the function <getNextCriterion> determines the criterion which will guide the next search. One or more local constraints may be set by the function <setLocalConstraints> (in this case, the function returns the boolean value “true”). The search for solutions optimizing the criterion “c” is performed by the function “maximize” as a function of the strategy defined for this criterion, which is given by getStrategy (c). The function “maximize” searches only for solutions globally preferred to “s*”. “maximize” returns “nil” if no solution has been found, otherwise, the variable “s*” is updated.

MCS gives the frame of a generic algorithm, that can be customized as a function of the problems tackled. This method may therefore be regarded as a “framework” of which instances will be produced by defining the various functions of which it is composed. In the subsequent description, we use a set \overline{u}₁, . . . , \overline{u}ₙ of values called upper bounds of the performance on each criterion. For a criterion iε1, . . . , n, \overline{u}ᵢ indicates the maximum value that can be obtained on the criterion i in an optimal solution. These values are therefore regularly updated in tandem with the search for solutions, either by virtue of functions which calculate an upper bound for each criterion, or when a monocriterion search proves that it has attained an optimum for the criterion that it optimizes. The details of the content of the various components of this “framework” give an appreciation of the variety of the algorithms which may be constructed in this way.

The function maximize(u[c], getStrategy(c)) launches a tree search for solutions according to a strategy specified for a selected criterion, denoted c. In all cases, the optimization is carried out according to the “branch and bound” principle by pruning the branches of the search tree that cannot lead to a more satisfactory solution both in the sense of the global preference relation and on the criterion c. One therefore defines a different search strategy for each criterion. The aim of this is to be able to find solutions of good quality on a given criterion. The strategy associated with a criterion “c” as fast as possible would therefore, in theory, be the one which would be used if the problem to be solved were the optimization of this criterion. For the same problem, it is possible to define a large number of search strategies by defining several separation functions or by using various exploration strategies. Depending on the complexity and the time constraints of the problem, it may also be beneficial to employ partial search strategies (a partial search strategy does not guarantee the attaining of an optimum in the selected criterion). For example, for each monocriterion search, it will be possible: to search only for a solution and not an optimal solution; to specify a time contract; to use a strategy that combines tree search and local search or even to launch a sequence of several different searches.

The definition of the function <getNextCriterion> determines the way in which the searches on the criteria follow one another. Of course, it is possible to program this function so that the algorithm strings the searches together always in the same order. However, it is more beneficial to construct a function which takes account of the information available at the moment of the search where it is invoked so as to make a dynamic choice. This information is, for example, the last solution found, the upper bounds of the performance that can be attained on each criterion, the importance of each criterion in the preference relation. It may make it possible to determine the criterion on which it is most beneficial to launch a search.

For example, we consider a solution s*, we denote by (u₁*, . . . , uₙ*) the representation of s* on the n criteria of the problem and \overline{u}₁, . . . , \overline{u}ₙ the maximum values that can be attained on these criteria. If we make the assumption that a search on a criterion i would make it possible to attain the maximum on this criterion without affecting the others, we can compare the n solutions represented over the space of criteria: (u₁*, . . . , \overline{u}ᵢ, . . . , uₙ*), i=1, . . . , n. The preferred solution then indicates the criterion with regard to which improvement is of most benefit.

The term local constraint is employed here to denote a constraint which will be valid only for the time of a search, unlike the constraints of the problem which must be satisfied constantly. The addition of one or of several local constraints is aimed at constraining a search to explore parts of the search space that are deemed to be particularly interesting at a given moment. Stated otherwise, constraining the search to produce a solution having a particular characteristic which ought to make it a more satisfactory solution than those already found.

For example, if the heuristic for choosing criteria has determined that it was more beneficial to improve the value u_{c}* of the last solution found according to the criterion “c”, adding a constraint “u_{c}>u_{c}*” or even “u_{c}≧1.1×u_{c}*” may make it possible to more rapidly find a solution of better quality than the solution found. Specifically, the choice of a strategy dedicated to the optimization of a particular criterion may be more effective but it does not guarantee that solutions improving this criterion will be found by priority.

The use of local constraints may make it possible to accelerate the convergence of the algorithm to a good quality solution but it also has a few disadvantages, especially if one is searching for an optimal solution to the problem: when a search which has been “overconstrained” by a local constraint does not find any solution, this does not necessarily imply that the optimal solution has been attained but that there is no better solution satisfying the local constraint. By using this type of constraint we therefore incur the risk of constructing algorithms which do not guarantee that an optimal solution will be found. The function <setLocalConstraints> returns a boolean which may be taken into account in the stopping condition and which makes it possible to indicate whether a local constraint has been set.

The algorithm terminates its run when the conditions contained in the function <checktermination> are satisfied or when the execution time allowed for the search has been exceeded (if a time contract has been specified). The stopping conditions of the algorithm may for example be: “the last search has not found any solution (s=nil)”, “the last search has not found any solution although no local constraint was set ((s=nil)&(not(local)))”.

The MCS “framework” relies on common principles shared by multicriterion optimization problems and therefore remains a relatively general context for defining algorithms for searching for solutions. In this section we present a few tools for the use of the method: firstly within the context of a problem where the preferences are modeled by an aggregation function to be maximized; then in the case where we desire to find an optimal solution to the problem.

A few exemplary heuristics for choosing criteria when the modeling of the preferences is carried out according to the “Aggregate then Compare” approach will now be presented.

The “Aggregate then Compare” (AC) approach calculates a global score for each solution by aggregating the performance of the solutions on each criterion. Within the MAUT context (MultiAttribute Utility Theory), the modeling of the preferences of the decision maker is carried out by virtue of an aggregation function H, which aggregates the values of the criteria u₁, . . . , uₙ and calculates the global evaluation of a solution. Let a and b be two solutions. We denote by u₁^{a}, . . . , uₙ^{a} and u₁^{b}, . . . , uₙ^{b} the performance of the solutions a and b with regard to the criteria of the problem. The function H is such that, for any pair of solutions a and b, a preferred to b is equivalent to H(u₁^{a}, . . . , uₙ^{a})>H(u₁^{b}, . . . , uₙ^{b}).

Within this context, we propose two heuristics for choosing criteria, each based on the construction of an indicator. These indicators are dependent on the last solution found s*, on its performance u₁*, . . . , uₙ* on each criterion and the maximum values \overline{u}₁, . . . , \overline{u}ₙ that may be attained on these criteria. In both cases, the indicator relies on the assumption that a search over a criterion will make it possible to find a solution of better quality with regard to this criterion and of equal quality with regard to the other criteria. We write u*=(u₁*, . . . , uₙ*) and \overline{u}=(\overline{u}₁, . . . , \overline{u}ₙ).

Indicator of maximum utility: for any criterion iε{1, . . . ,n} the indicator of maximum utility, denoted χᵢ(H)(u*, \overline{u}), is the value χᵢ(H)(u*, \overline{u})=H(u₁*, . . . , u*ᵢ₋₁, \overline{u}ᵢ, u*ᵢ₊₁, . . . , uₙ*). This is the global level of satisfaction which would be attained if a search on criterion i would make it possible to attain a solution of maximum level of satisfaction with regard to this criterion without degrading the satisfaction of the other criteria with respect to the previous solution.

Indicator of mean utility: the value \overline{u}ᵢ is an upper bound of the maximum value that can be attained on criterion i. In the majority of optimization problems, it is rather improbable that it is always possible to find a solution which makes it possible to attain this value, especially without degrading the performance with regard to the other criteria. In certain cases it may therefore be more judicious to calculate the mean value of the function H for values of the criterion i varying between uᵢ* and \overline{u}ᵢ. This value, denoted ωᵢ(H) (u*, \overline{u}) may be obtained by calculating the integral

$${ω}_{i} ( H ) ( {u}^{*} , \overline{u} ) = \frac{1}{{\overline{u}}_{i} - {u}_{i}^{*}} {\int }_{x = {u}_{i}^{*}}^{{\overline{u}}_{i}} H ( {u}_{1}^{*} , K , {u}_{i - 1}^{*} , x , {u}_{i + 1}^{*} , K , {u}_{n}^{*} ) ⅆ x .$$

A heuristic for choosing criteria constructed on the basis of this type of indicator returns the index of the criterion which obtained the highest value of the indicator.

The Choquet integral (M. Grabisch, “The application of fuzzy integrals in multicriteria decision making”, European Journal of Operational Research, 89, 1996, pp. 445-456) is a very general aggregation function, which contains as particular case the usual aggregation operators such as the minimum, the maximum, the median, the weighted mean and the weighted ordered mean (or ordered weighted average OWA). It makes it possible to model not only the importance of the criteria, but also the interaction phenomena between the various coalitions of criteria. Let N={1, . . . , n} be the set of criteria. A fuzzy measure on N associates with each A⊂N a number μ(A)⊂[0.1] such that μ(Ø)=0, μ(N)=1 and A⊂N [symbol] μ(A)≦μ(B).

We recall here the definition of the Choquet integral:

Let μ be a fuzzy measure on N and u=(u₁, . . . , uₙ). The Choque integral t C_{μ} of the vector u with respect to μ is defined by:

$${C}_{μ} ( {u}_{1} , K , {u}_{n} ) = {\sum }_{i = 1}^{n} ( {u}_{σ ( i )} - {u}_{σ ( i - 1 )} ) ⨯ μ ( {A}_{σ ( i )} )$$

with
0≦u_{σ(1)}≦K≦u_{σ(n)}≦1,A_{σ(i)}={σ(i),K,σ(n)},etu_{σ(0)}=0.

In the case where the Choquet integral is used as aggregation function, the indicators presented above are therefore the following:

Indicator of maximum utility: χᵢ(C_{μ}) (u*, \overline{u})=C_{μ} (u₁*, . . . , u*ᵢ₋₁, \overline{u}ᵢ, u*ᵢ₊₁, . . . , uₙ*).

Indicator of mean utility:

$${ω}_{i} ( {C}_{μ} ) ( {u}^{*} , \overline{u} ) = \frac{1}{{\overline{u}}_{i} - {u}_{i}^{*}} {\int }_{x = {u}_{i}^{*}}^{{\overline{u}}_{i}} {C}_{μ} ( {u}_{1}^{*} , K , {u}_{i - 1}^{*} , x , {u}_{i + 1}^{*} , K , {u}_{n}^{*} ) ⅆ x .$$

According to the definition of its components, the “framework” may be used to implicitly perform a complete traversal of the search tree and make it possible to find an optimal solution for sure. A search strategy is said to be complete if it makes it possible to find a solution to a problem when the former exists. Consequently, if a complete search does not find a solution, it is because one does not exist. In general a search is said to be complete when it “does not forget” any solution.

An optimal solution may therefore be said to be found for the multicriterion problem in two cases:

when a solution whose performance with regard to each criterion is equal to the upper bound of the performance of the criterion has been found;

when a monocriterion search having the property of being complete has not found any solution of better quality than the solutions found during previous searches. (Remark: if no solution had been found previously, then the problem does not admit of a solution).

Likewise, in the MCS context there are two types of incomplete search:

searches whose strategy for traversing the tree are incomplete (also called partial searches);

searches for solutions to problems that are more constrained than the initial problem.

Typically, if a search which is “overconstrained” by a local constraint does not find any solution, it is not possible to conclude that there is no solution to the problem which is better than the solutions found during the previous searches. This simply makes it possible to say that no solution exists which satisfies the constraint set (and possibly to decrease the value of the upper bound of a criterion if the local constraint was a constraint of improving a criterion). On the other hand, in the absence of local constraints, the search for the optimum on a criterion, even if we limit the number of solutions found, is a complete search, since it guarantees that at least one solution to the problem will be found, if it exists.

We therefore propose a stopping condition and two functions for adding local constraints which, associated with complete monocriterion search strategies, make it possible to find an optimal solution to the global problem.

Let “s*” be the last solution found, “c” the criterion selected by the function <getNextCriterion>. The variable “u[c]” models the criterion “c” to be maximized and the function getValue(s*, c) returns the performance of the solution “s*” for the criterion “c”. The principle proposed is to set just one type of constraint when a criterion “c” has been selected by the function <getNextCriterion>: the constraint u[c]>getValue(s*, c). This constraint is called the constraint of improvement of the criterion “c”. Two modes for posing it are proposed:
A “systematic” mode: the constraint is set at each search.
A “consecutive” mode: the constraint is set only when the criterion “c” has also been selected to guide the previous search.

When MCS is used with one of the two functions for adding local constraints above, the function <checkTermination> may be redefined so that MCS stops only after having found an optical solution. The function “optimalitycondition” below ensures this role in both cases:

optimalityCondition(local,s*,s,u,c)

if(c = 0)

return false

else if checkUpperBounds(s*,u)

return true

else if(s = nil)

if(local)

setConstraint(u[c] ≦ getValue(s*,c)),
return false

else return true
endif

else return false
endif

end

The case c=0 makes it possible not to satisfy the condition before the first iteration. Firstly, the function “checkUpperBounds” verifies whether the performance of the solution “s*” with regard to each criterion is equal to the upper bound of the performance of the criterion. Otherwise, the variable “local” makes it possible to stop the algorithm when a search that was not subject to a local constraint does not find any solution (a search which does not find any solution returns “nil”). If a search on the criterion “c”, subject to a local constraint returns “nil”, the function “setConstraint” reduces the upper bound of the criterion “c” by posing the constraint u[c]<getValue(s*, c). By assuming that the function <getNextCriterion> does not select a criterion when the performance of “s*” with regard to this criterion is equal to its upper bound, the algorithm necessarily terminates and returns an optimal solution. The function “optimalitycondition” also makes it possible to find the optimum when no local constraint is set.

More generally, it is noted that the function <checkTermination> is launched after each search and it may therefore also be used to introduce new cuts of the search space (for example, to reduce the upper bounds of the criteria).

The Programming by Constraints (PPC) offers a technical context for modeling combinatorial optimization problems. The solution process is based on the collaboration between a process which constructs a search tree for the search for solutions and a process which propagates the constraints of the problem to each node of the tree so as to reduce the search space and ensure the validity of the solutions found. In PPC, a certain number of tools have been designed to aid the design of optimization algorithms. They allow relatively easy definition of the strategies for searching for solutions to mono-objective problems. The modeling of multicriteria preferences is also achievable within this context, in particular by integrating aggregation functions such as the Choquet integral (F. Le Huédé, P. Gérard, M. Grabisch, C. Labreuche and P. Savéant, Integration of a Multicriteria Decision Model in Constraint Programming, proceedings of the AIPS'02 Workshop on Planning and Scheduling with Multiple Criteria, Toulouse, France, Apr. 23-27, 2002).

PPC is therefore an ideal context for implementing the MCS “framework”, since a large number of tools have already been created for modeling the constraints of problems and modeling the preferences between the solutions and the description of the search strategies. With the objective of facilitating the use of MCS, it will be possible to construct a library containing the various instances of the functions of the “framework” that are presented in the present description.

In conclusion, the MCS framework makes it possible to construct algorithms for searching for solutions to a multicriterion optimization problem. The principle of the algorithm relies on the alternating of monocriteria search strategies for searching for a preferred solution within the sense of a multicriterion preference relation. MCS is designed to be able to operate with tools stemming from multicriterion decision aid which possesses important capabilities for modeling the preferences of an expert. Hence, various search strategies are used not to exhibit an important set of nondominated solutions, but to accelerate the convergence of the algorithm towards an optimal solution. Within this context, a monocriterion search may take various forms (for example: following an incomplete strategy, being interrupted as soon as it has found a solution, etc.). Between each search, a criterion is selected by a criterion choice heuristic.

It determines the strategy which will be adopted for the next search for solutions. This selection makes it possible to determine the criterion with regard to which there is the greatest benefit in improvement at a moment of the search and of more rapidly finding solutions that are more satisfactory. The addition of “local” constraints to the various searches may also make it possible to accelerate the convergence of the algorithm to the optimal solution. Finally, the stopping condition of the algorithm is defined, thus making it possible to construct partial searches or to provide proof of the optimality of the last solution found.

1. A method for producing solutions to a concrete problem of multicriterion optimization according to which several decision criteria and a preference relation based on these criteria between the solutions of the problem are established comprising the steps of:
modeling the problem to be solved;
obtaining solutions constructively via a tree search process;
establishing a tree search strategy for each criterion;
alternating the strategies so as to find solutions of increasing quality;
dynamically the strategies choosing as a function of the last solution found;
the alternation of strategies continues until a stopping condition is satisfied;
the last solution found before the satisfaction of the stopping condition is exhibited as the solution to the problem set.

2. The method as claimed in claim 1, wherein the preference relation between the solutions of the problem is modeled by an aggregation function (H).

3. The method as claimed in claim 2, wherein the aggregation function of the criteria H is a Choquet integral (Cμ).

4. The method as claimed in claim 1, wherein following each search, the value of an indicator is determined for each criterion as a function of the last solution found and that this indicator makes it possible to determine the strategy which will be used during the next search.

5. The method as claimed in claim 4, wherein the indicator used for the dynamic choice of a strategy is the indicator of maximum utility (χᵢ).

6. The method as claimed in claim 4, wherein the indicator used for the dynamic choice of a strategy is the indicator of mean utility (ωᵢ).

7. The method as claimed in claim 1, wherein local constraints are set on the various searches.

8. The method as claimed in claim 7, wherein the local constraint set for a search on a criterion is a constraint of improving this criterion and that this constraint is set at each search.

9. The method as claimed in claim 7, wherein the local constraint set for a search on a criterion is a constraint of improving this criterion and that this constraint is set only when a criterion is selected several times in succession to guide the search, starting from the second consecutive search on this criterion.

10. The method as claimed in claim 1, wherein the strategies associated with the various criteria, the local constraints on the searches and the stopping condition in the search process are used to find an optimal solution to the problem and to prove the optimality of this solution.

11. The method as claimed in claim 1, wherein the modeling of the problem and the search for solutions are carried out in a constraints solver.

12. The method as claimed in claim 2, wherein local constraints are set on the various searches.

13. The method as claimed in claim 3, wherein local constraints are set on the various searches.

14. The method as claimed in claim 2, wherein the modeling of the problem and the search for solutions are carried out in a constraints solver.

15. The method as claimed in claim 3, wherein the modeling of the problem and the search for solutions are carried out in a constraints solver.

16. The method as claimed in claim 4, wherein the modeling of the problem and the search for solutions are carried out in a constraints solver.

17. The method as claimed in claim 5, wherein the modeling of the problem and the search for solutions are carried out in a constraints solver.

18. The method as claimed in claim 6, wherein the modeling of the problem and the search for solutions are carried out in a constraints solver.

19. The method as claimed in claim 7, wherein the modeling of the problem and the search for solutions are carried out in a constraints solver.

20. The method as claimed in claim 8, wherein the modeling of the problem and the search for solutions are carried out in a constraints solver.
